(19) United States
(12) Patent Application Publication
(10) Pub. No.: US 2026/0109355 A1
(43) Pub. Date: Apr. 23, 2026

(54) DRIVER STATE DETECTION DEVICE, DRIVER STATE DETECTION METHOD, AND STORAGE MEDIUM

(71) Applicant: HONDA MOTOR CO., LTD., Tokyo (JP)

(72) Inventors: Hirotaka Katayama, Tokyo (JP); Yuichi Masukake, Tokyo (JP); Kazuma Hamada, Tokyo (JP)

(21) Appl. No.: 19/356,231

(22) Filed: Oct. 13, 2025

(30) Foreign Application Priority Data
Oct. 18, 2024 (JP) 2024-184163

(51) Int. Cl. B60W 40/08; B60Q 1/34; B60W 30/18; G06V 20/59; G06V 40/18

(52) U.S. Cl. CPC B60W 40/08; B60Q 1/343; B60W 30/18163; G06V 20/597; G06V 40/18; B60W 2420/403; B60W 2520/10; B60W 2540/225; B60W 2552/05

(57) ABSTRACT

A driver state detection device includes: a recognizer configured to recognize at least one of a gaze and a face direction of a driver of a mobile object; a determiner configured to determine whether a monitoring direction of the driver is appropriate on the basis of a result of recognition from the recognizer; and a lighting controller configured to perform lighting control of a direction indicator of the mobile object according to the driver's operation of an operator for lighting the direction indicator and to perform control such that lighting is maintained even when the operator returns to a neutral position. The determiner makes it more difficult to determine that the monitoring direction of the driver is not appropriate in comparison with before the operator is operated until the operator returns to the neutral position and a predetermined condition is satisfied.

### CROSS-REFERENCE TO RELATED APPLICATION

Priority is claimed on Japanese Patent Application No. 2024-184163, filed Oct. 18, 2024, the content of which is incorporated herein by reference.

### BACKGROUND

### Field of the Invention

The present invention relates to a driver state detection device, a driver state detection method, and a storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on preventive safety technology. In this regard, a technique of acquiring first detection information indicating a gaze or a face direction of a driver as a change pattern and temporarily changing a determination condition set to determine a sideways glance when the change pattern corresponds to a preset reference pattern according to a lane checking motion of the driver is known in the related art (for example, see Japanese Unexamined Patent Application, First Publication No. 2019-91275). In the technique disclosed in Japanese Unexamined Patent Application, First Publication No. 2019-91275, it is described that the determination condition is temporarily switched in a period in which a direction indicator is operating. When an operator such as a turn signal lever for operating the direction indicator is operated from a neutral position by the driver, the operator is maintained in a state in which it has moved to a position instructed by the operation and turns on the direction indicator corresponding to the instructed direction. Thereafter, when a predetermined steering operation is performed through an operation on a steering wheel, the operator returns to the neutral position again and ends the operation (turning-on) of the direction indicator.

### SUMMARY

Recently, there have been mobile objects having a function (a so-called one-touch turn signal function) of returning an operator to a neutral position when a driver removes a hand from the operator after having operated the operator and turning on a direction indicator a predetermined number of times or for a predetermined time after the operator has been returned to the neutral position. The driver notifies the surroundings of a lane change destination by turning on the direction indicator a predetermined number of times or for a predetermined time using this function and performs lane change after the turning-on. However, in the related art, since the operation (turning-on) of the direction indicator ends before the lane change is completed due to this function, the determination condition is also returned to original conditions, and movement of the gaze or the face direction due to the subsequent lane change may be determined to be a sideways glance. In this way, in the related art, a driver state may not be able to be appropriately detected.

In order to solve the aforementioned problem, an objective of the present invention is to provide a driver state detection device, a driver state detection method, and a storage medium that can more appropriately detect a driver state. Another objective thereof is to contribute to advancement of a sustainable transportation system.

A driver state detection device, a driver state detection method, and a storage medium according to the present invention employ the following configurations.
(1) According to an aspect of the present invention, there is provided a driver state detection device including: a recognizer configured to recognize at least one of a gaze and a face direction of a driver of a mobile object; a determiner configured to determine whether a monitoring direction of the driver is appropriate on the basis of a result of recognition from the recognizer; and a lighting controller configured to perform lighting control of a direction indicator of the mobile object according to the driver's operation of an operator for lighting the direction indicator and to perform control such that lighting is maintained even when the operator returns to a neutral position, wherein the determiner makes it more difficult to determine that the monitoring direction of the driver is not appropriate in comparison with before the operator is operated until the operator returns to the neutral position and a predetermined condition is satisfied.
(2) In the aspect of (1), the predetermined condition may include a condition in which a predetermined time has elapsed or the mobile object has moved by a predetermined distance or more after the operator has been operated or the operator has returned to the neutral position.
(3) In the aspect of (1), the predetermined condition may include a condition in which a predetermined time has elapsed or the mobile object has moved by a predetermined distance or more after lighting of the direction indicator has ended.
(4) In the aspect of (2) or (3), when lateral behavior of the mobile object or an operation for causing lateral behavior occurs before the predetermined time has elapsed or in a state in which the mobile object has moved by less than the predetermined distance, the determiner may make it more difficult to determine that the monitoring direction of the driver is not appropriate until the lateral behavior or the operation for causing the lateral behavior ends even if the predetermined time has elapsed or the mobile object has moved by the predetermined distance or more.
(5) In the aspect of (2) or (3), when lateral behavior of the mobile object or an operation for causing the lateral behavior occurs before the predetermined time has elapsed or in a state in which the mobile object has moved by less than the predetermined distance, the determiner may make it more difficult to determine that the monitoring direction of the driver is not appropriate until the mobile object crosses a marking line of a lane in which the mobile object is moving or until right and left marking lines of the mobile object are recognized after the mobile object has adopted the lateral behavior even if the predetermined time has elapsed or the mobile object has moved by the predetermined distance or more.
(6) In the aspect of (1), the operation of the operator may be an operation of starting automatic lane change of the mobile object, and the predetermined condition may include a condition in which the automatic lane change has been completed.
(7) In the aspect of (1), the predetermined condition may include a condition in which the mobile object is moving on an exclusive road or a condition in which the mobile object is moving at a predetermined speed or higher.
(8) In the aspect of (1), the predetermined condition may include a first predetermined condition which is used when the mobile object is moving on an exclusive road or the mobile object is moving at a predetermined speed or higher and a second predetermined condition which is used when the mobile object is moving on a road other than the exclusive road or the mobile object is moving at lower than the predetermined speed, and the first predetermined condition may be satisfied more difficultly than the second predetermined condition.
(9) According to another aspect of the present invention, there is provided a driver state detection method that is performed by a computer, the driver state detection method including: recognizing at least one of a gaze and a face direction of a driver of a mobile object; determining whether a monitoring direction of the driver is appropriate on the basis of a result of recognition; performing lighting control of a direction indicator of the mobile object according to the driver's operation of an operator for lighting the direction indicator and performing control such that lighting is maintained even when the operator returns to a neutral position; and making it more difficult to determine that the monitoring direction of the driver is not appropriate in comparison with before the operator is operated until the operator returns to the neutral position and a predetermined condition is satisfied.
(10) According to another aspect of the present invention, there is provided a non-transitory computer-readable storage medium storing a program, the program causing a computer to perform: recognizing at least one of a gaze and a face direction of a driver of a mobile object; determining whether a monitoring direction of the driver is appropriate on the basis of a result of recognition; performing lighting control of a direction indicator of the mobile object according to the driver's operation of an operator for lighting the direction indicator and performing control such that lighting is maintained even when the operator returns to a neutral position; and making it more difficult to determine that the monitoring direction of the driver is not appropriate in comparison with before the operator is operated until the operator returns to the neutral position and a predetermined condition is satisfied.

According to the aspects of (1) to (10), it is possible to more appropriately detect a driver state.

### BRIEF DESCRIPTION OF THE DRAWINGS

FIG. 1 is a diagram illustrating a configuration of a vehicle system including a driver state detection device according to an embodiment.

FIG. 2 is a diagram illustrating a relationship between a driver's gaze (face direction) and sideways-glance determination conditions.

FIG. 3 is a diagram illustrating a changed sideways-glance determination area.

FIG. 4 is a diagram illustrating an operation position of a turn signal lever.

FIG. 5 is a diagram illustrating a turn signal operation and a determination process according to a first example.

FIG. 6 is a diagram illustrating a turn signal operation and a determination process according to a second example.

FIG. 7 is a flowchart illustrating an example of a process flow that is performed by a driving support device according to the embodiment.

FIG. 8 is a flowchart illustrating an example of a sideways-glance determination process.

### DESCRIPTION OF EMBODIMENTS

Hereinafter, a driver state detection device, a driver state detection method, and a storage medium according to an embodiment of the present invention will be described with reference to the accompanying drawings. In the following description, it is assumed that a vehicle is used as an example of a mobile object. Examples of the mobile object may include a ship which can move on the ground (on a road) such as a hovercraft, a flying object which can travel on a road, and a standing riding vehicle including a power unit in addition to a vehicle.

### Entire Configuration

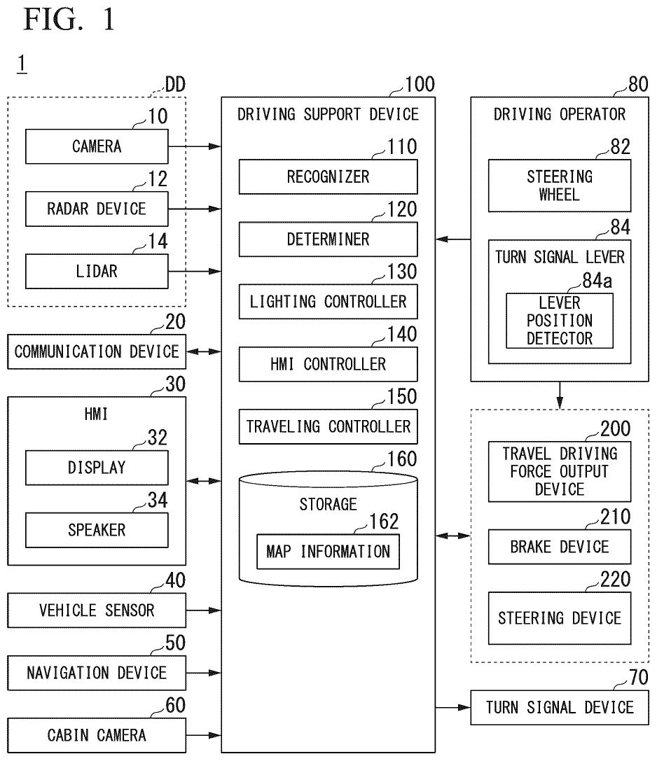

FIG. 1 is a diagram illustrating a configuration of a vehicle system 1 employing a driver state detection device according to an embodiment. A vehicle in which the vehicle system 1 is mounted (hereinafter referred to as a vehicle M) is, for example, a vehicle with two wheels, three wheels, or four wheels or micromobility, and a drive source thereof is an internal combustion engine such as a diesel engine or a gasoline engine, an electric motor, or a combination thereof. The electric motor operates using electric power generated by a power generator connected to the internal combustion engine or using electric power discharged from a battery (storage battery) such as a secondary battery or a fuel cell.

The vehicle system 1 includes, for example, a camera 10, a radar device 12, a Light Detection and Ranging (LIDAR) device 14, a communication device 20, a human-machine interface (HMI) 30, a vehicle sensor 40, a navigation device 50, a cabin camera 60, a turn signal device 70, a driving operator 80, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto. A combination of the camera 10, the radar device 12, and the LIDAR device 14 is an example of a “detection device DD.” The HMI 30 is an example of an “alarm.” The turn signal device 70 is an example of a “direction indicator.”

The camera 10 is, for example, a digital camera using a solid-state imaging device such as a charge coupled device (CCD) or a complementary metal oxide semiconductor (CMOS). The camera 10 is attached to an arbitrary position on the vehicle M in which the vehicle system 1 is mounted. When a forward view is imaged, the camera 10 is attached to an upper part of a front windshield, a rear surface of a rearview mirror, a front head of a vehicle body, or the like. When a rearward view is imaged, the camera 10 is attached to an upper part of a rear windshield, a back door, or the like. When a side view is imaged, the camera 10 is attached to a door mirror or the like. The camera 10 images the surroundings of the vehicle M, for example, periodically and repeatedly. The camera 10 may be a stereo camera.

The radar device 12 radiates radio waves (radiated waves) such as millimeter waves to the surroundings of the vehicle M, detects radio waves (reflected waves) reflected by a nearby object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The communication device 20 communicates with other vehicles near the vehicle M, a terminal device of a user using the vehicle M, or various server devices, for example, using a network such as a cellular network, a Wi-Fi network, Bluetooth (registered trademark), or dedicated short range communication (DSRC), a local area network (LAN), a wide area network (WAN) or the Internet.

The HMI 30 outputs various types of information to an occupant (who includes a driver) of the vehicle M and receives an input operation from the occupant. The HMI 30 includes, for example, a display 32 and a speaker 34. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm sound). The HMI 30 may include a microphone, buzzers, a touch panel, switches, and keys in addition to (or instead of) the display 32 and the speaker 34.

The vehicle sensor 40 includes a vehicle speed sensor that detects a speed of the vehicle M, an acceleration sensor that detects acceleration, a yaw rate sensor that detects a yaw rate (an angular velocity around a vertical axis passing through the center of gravity of the vehicle M). The vehicle sensor 40 may include a lateral acceleration sensor (a lateral G sensor) that detects a lateral acceleration (a lateral G) of the vehicle M, a rudder angle sensor that detects a rudder angle (which may be an angle of turning wheels or an operation angle of a steering wheel) or a steering torque of the vehicle M, a rudder angular velocity sensor that detects a rudder angular velocity, or a direction sensor that detects a direction of the vehicle M.

The vehicle sensor 40 may include a position sensor that detects a position of the vehicle M. The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50. The vehicle sensor 40 may derive the speed of the vehicle M from a difference in position information in a predetermined time (that is, a distance) in the position sensor. Results detected by the vehicle sensor 40 are output to the driving support device 100.

The navigation device 50 includes, for example, a GNSS receiver, a navigation HMI, and a route determiner. The navigation device 50 may store map information in a storage device such as a hard disk drive (HDD) or a flash memory or acquire map information 162 stored in a storage 160 which will be described later. The GNSS receiver identifies the position of the vehicle M on the basis of signals received from GNSS satellites. The position of the vehicle M may be identified or corrected by an inertial navigation system (INS) using the output of the vehicle sensor 40. The navigation HMI includes a display device, a speaker, a touch panel, and keys. The GNSS receiver may be provided in the vehicle sensor 40. The navigation HMI may be partially or wholly shared by the HMI 30. For example, the route determiner determines a route (hereinafter referred to as a route on a map) from the position of the vehicle M identified by the GNSS receiver (or an input arbitrary position) to a destination input by an occupant using the navigation HMI, for example, with reference to the map information 162. The navigation device 50 performs route guidance using the navigation HMI on the basis of the determined route on a map. The navigation device 50 may transmit a current position and a destination to a navigation server via the communication device 20 and acquire a route which is equivalent to the route on a map from the navigation server.

Here, the map information 162 is, for example, information in which a road shape is expressed by links indicating a road (an example of a traveling lane) and nodes connected by the links. The map information 162 may include point of interest (POI) information. The map information 162 includes, for example, the number of lanes (the number of traveling lanes), a type or shape of road marking lines, information of a lane center, or information of road boundaries. The map information 162 may include information indicating whether a road boundary is a boundary (a physical boundary) including a structure which a vehicle cannot pass through (which includes crossing or contacting). A physical boundary is, for example, a guardrail, a curbstone, a median strip, or a fence. The map information 162 may include road shape information, traffic regulation information, address information (addresses and postal codes), facility information, parking lot information, and phone number information. The road shape information is, for example, information on a curvature (which may be a radius of curvature; the same is true of the following description), a width, a surface gradient, a branching or merging point, a crossing, or a T-road of a road. The map information 162 may be updated from time to time by causing the communication device 20 to communicate with an external device.

The cabin camera 60 is, for example, a digital camera using a solid-state imaging device such as a CCD or a CMOS device. The cabin camera 60 is attached to an arbitrary position on the vehicle M in a place and a direction in which the head of a driver sitting on a driver's seat of the vehicle M can be imaged from the front (such that the face of the driver is imaged). For example, the cabin camera 60 is attached to an upper part of a display device which is provided at the center of an instrument panel of the vehicle M. The cabin camera 60 images the cabin in an area including an occupant (passenger) sitting on a passenger's seat of the vehicle M.

The turn signal device 70 controls an operation of starting or stopping a turn signal according to information input from the driving support device 100 or information input from the driving operator 80. The turn signal is, for example, a lamp indicating a direction of the right or left turn or a course changing direction using lighting (flickering). When a driver operates a turn signal lever 84 which will be described later, the turn signal device 70 operates the turn signal corresponding to a lever position detected by a lever position detector 84a. The turn signal device 70 outputs information indicating that the turn signal is operating to the driving support device 100 while the turn signal is operating.

The driving operator 80 includes, for example, a steering wheel 82 and a turn signal lever 84. The turn signal lever 84 is an example of an “operator for lighting a direction indicator of a mobile object (the vehicle M).” The driving operator 80 includes an accelerator pedal, a brake pedal, a shift lever, and other operators. A sensor that detects an amount of operation or whether an operation has been performed is attached to the driving operator 80.

The steering wheel 82 is an example of an “operator for receiving a steering operation from a driver.” The steering wheel 82 does not have to have a ring shape and may have a shape such as a deformed steering wheel, a joystick, or a button. A steering grasp sensor (not illustrated) is attached to the steering wheel 82. The steering grasp sensor is realized by a capacitance sensor or the like and outputs a signal indicating whether an occupant (a driver) grasps the steering wheel 82 (which means that the occupant grasps the steering wheel with a force applied thereto) to the driving support device 100.

A lever position detector 84a is provided in the turn signal lever 84. The lever position detector 84a detects a position of the turn signal lever 84. Details of this position detection will be described later. The turn signal lever 84 has a one-touch turn signal function of allowing the turn signal lever 84 to return automatically to a neutral position when the driver removes a hand after it has been operated and lighting a direction indicator a predetermined number of times or for a predetermined time even after returning to the neutral position.

A detector provided in the accelerator pedal or the brake pedal detects an amount of depression of the corresponding pedal, and a detector provided in the steering wheel detects a steering angle or a steering torque of the steering wheel 82. Then, the detectors (which include the lever position detector 84a) output a detection signal indicating the results of detection to the driving support device 100 or some or all of the travel driving force output device 200, the brake device 210, and the steering device 220.

The driving support device 100 performs various types of control for supporting driving of the driver of the vehicle M. The driving support device 100 includes, for example, a recognizer 110, a determiner 120, a lighting controller 130, an HMI controller 140, a traveling controller 150, and a storage 160. The recognizer 110, the determiner 120, the HMI controller 140, and the traveling controller 150 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD, a CD-ROM, or a memory card and installed in the storage device of the driving support device 100 by setting the storage medium (a non-transitory storage medium) into a drive device or a card slot. The HMI controller 140 is an example of an “alarm controller.” The driving operator 80, the recognizer 110, the determiner 120, the lighting controller 130, and the HMI controller 140 are an example of a “driver state detection device.”

The storage 160 may be realized by the aforementioned various storage devices, an electrically erasable programmable read only memory (EEPROM), a read only memory (ROM), a random access memory (RAM), or the like. For example, the map information 162 and various types of information and programs in the embodiment are stored in the storage 160. Various types of setting information used in processes according to the present embodiment may be stored in the storage 160.

The recognizer 110 recognizes a surrounding situation of the vehicle M, for example, on the basis of the results of detection from a detection device DD (information input from the camera 10, the radar device 12, and the LIDAR device 14). For example, the recognizer 110 recognizes states such as a position (relative position), a size, a speed (relative speed), and an acceleration of an object near the vehicle M (for example, within a predetermined distance from the vehicle M) by performing a sensor fusion process on the results of detection from some or all of the camera 10, the radar device 12, and the LIDAR device 14. Examples of the object recognized by the recognizer 110 include a traffic participant (an example of an obstacle) such as another vehicle, a pedestrian, or a bicycle in addition to the physical boundaries defining a road (a traveling lane). For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include, for example, an acceleration or a jerk of a mobile object or a “moving state” (for example, whether another vehicle is performing lane change or whether another vehicle is going to performing lane change) when the object is a mobile object such as another vehicle.

The recognizer 110 recognizes, for example, a lane (a traveling lane) in which the vehicle M is traveling or a lane (for example, an opposing lane) near the traveling lane. For example, the recognizer 110 recognizes road marking lines from an image captured by the camera 10 and recognizes the traveling lane or other lanes on the basis of the recognized positional relationship between the vehicle M and the road marking lines. The recognizer 110 may recognize the traveling lane of the vehicle M and other lanes with reference to map information 162 on the basis of the position information of the vehicle M acquired from the vehicle sensor 40 or the like. The recognizer 110 may recognize, for example, a stop line, a red signal, a toll gate, other road events, a road sign, or a marking drawn on a road (for example, a speed limit).

The recognizer 110 recognizes a state of an occupant of the vehicle M using an image captured by the cabin camera 60. For example, the recognizer 110 performs a known image analysis process on the image captured by the cabin camera 60 and recognizes a gaze of the driver (a direction in which the driver is gazing) of the vehicle M or a face direction of the driver on the basis of a result of analysis.

For example, the recognizer 110 detects a combination of a reference point (a part in which the eye does not move) and a moving point (a part in which the eye moves) of eyes of the driver from the image using a technique such as template matching. The combination of the reference point and the moving point is, for example, a combination of an inner canthus and an iris or a combination of a corneal reflection area and a pupil. The corneal reflection area is an infrared reflection area in a cornea when the cabin camera 60 or the like irradiates the driver with infrared light. Then, the recognizer 110 recognizes a gaze of the driver by performing coordinate conversion from an image plane to a real space on the basis of the position of the moving point relative to the reference point. The recognizer 110 recognizes a face direction of the driver on the basis of position information of eyes, a nose, a mouse or the like (relative position information of the regions) in a face area acquired from the analysis result of an image.

When there is an occupant (for example, a passenger sitting on the passenger's seat) other than the driver, the recognizer 110 may recognize a position, a gaze, a face direction, or the like of the occupant. In the aforementioned recognition of various types of information using an image, for example, a trained model which has been trained through machine learning or the like in advance may be used.

The recognizer 110 recognizes behavior of the vehicle M on the basis of the detection results from the vehicle sensor 40. For example, the recognizer 110 recognizes a lateral position of the vehicle M (a position in a lane width direction) with respect to the traveling lane or a posture (direction) of the vehicle M with respect to an extending direction of the traveling lane on the basis of the positional relationship between the vehicle M and the traveling lane. For example, the recognizer 110 may recognize a degree of separation of a reference point of the vehicle M from the lane center and an angle of the traveling direction of the vehicle M with respect to a line formed by connecting the lane centers as the relative position and the relative posture of the vehicle M with respect to the traveling lane. Instead, the recognizer 110 may recognize a position of the reference point of the vehicle M with respect to one side line of the traveling lane (a road marking line or a road boundary) or the like as the relative position (a lateral position) of the vehicle M with respect to the traveling lane. The recognizer 110 may recognize lateral behavior of the vehicle M (for example, when the vehicle M moves laterally by a predetermined distance or longer) from the lateral position of the vehicle M or an amount of change in direction of the vehicle M. The recognizer 110 may recognize the lateral behavior of the vehicle M on the basis of the values of the rudder angle, the steering torque, the rudder angular velocity (a rudder angle differential), the yaw rate, and the like of the vehicle M acquired from the vehicle sensor 40 or at least one value of a steering torque and a rate of change in steering torque acquired from the driving operator 80.

The determiner 120 determines whether the driver is performing sideways-glance driving on the basis of at least one of the gaze and the face direction of the driver recognized by the recognizer 110 and a preset sideways-glance determination condition. When it is determined that the driver is performing sideways-glance driving, the determiner 120 notifies an occupant including the driver by causing the HMI controller 140 to output alarm information on the sideways-glance driving. The alarm information is, for example, sideways-glance information such as information for notifying that a sideways glance has been detected or information for attracting attention against a sideways glance and includes at least one of an image and sound (alarm sound).

The determiner 120 determines whether predetermined steering is being performed on the vehicle M on the basis of the results of detection from the vehicle sensor 40 or information on the behavior of the vehicle M recognized by the recognizer 110. The predetermined steering is, for example, steering accompanying lane change of the vehicle M. The predetermined steering may be, for example, steering for a right or left turn of the vehicle M or steering during traveling on a curved road, traveling with lateral fluctuations, or the like. The determiner 120 may change the sideways-glance determination condition when it is determined that the predetermined steering is being performed.

The determiner 120 determines whether a monitoring direction of the driver is appropriate on the basis of the results of recognition from the recognizer 110. An appropriate monitoring direction is, for example, a direction with a predetermined range (angle) based on the traveling direction of the vehicle M, a nearby road shape, or the like. For example, the determiner 120 determines whether the driver is performing sideways-glance driving (driving the vehicle M while glancing sideways) as an example for determining whether the monitoring direction is appropriate. Details of the process performed by the determiner 120 will be described later.

The lighting controller 130 performs lighting control of a turn signal according to a driver's operation on the turn signal lever 84 for lighting the turn signal (direction indicator) of the vehicle M. For example, the lighting controller 130 lights (flickers) the turn signal correlated with an operation position (direction) while the turn signal lever 84 is maintained at the position operated by the driver. The lighting controller 130 ends flickering of the turn signal when the turn signal lever 84 has returned to the neutral position. When the turn signal lever 84 has the one-touch turn signal function, the lighting controller 130 may perform the control such that lighting is maintained until a predetermined lighting condition is satisfied even when the turn signal lever 84 returns to the neutral position because the driver removes a hand from the turn signal lever 84. The lighting condition is, for example, a condition in which a predetermined time has elapsed after the hand has been removed or a condition in which the turn signal has flickered a predetermined number of times.

The HMI controller 140 notifies an occupant of predetermined information using the HMI 30 or receives information input by the HMI 30. The predetermined information includes, for example, information associated with traveling of the vehicle M such as information on the state of the vehicle M or information on driving control. The information on the state of the vehicle M includes, for example, a speed, an engine rotation speed, and a shift position of the vehicle M and details of the lighting control performed by the lighting controller 130. The information on driving control includes, for example, information indicating whether driving control is to be performed by the traveling controller 150 or information on an execution situation of driving control. The predetermined information may include information on the surrounding situation recognized by the detection device DD. The predetermined information may include information not associated with traveling of the vehicle M such as television programs and content (for example, movies) stored in a storage medium such as a DVD. The predetermined information may include information on a current position or a destination of the vehicle M and a residual amount of fuel of the vehicle M. The HMI controller 140 may output the information received by the HMI 30 to the communication device 20, the recognizer 110, the determiner 120, the navigation device 50, and the like.

The HMI controller 140 may cause the HMI 30 to output inquiry information for an occupant, the recognition results from the recognizer 110, the determination results from the determiner 120, and the like. The HMI controller 140 may transmit various types of information which the HMI 30 is caused to output to a terminal device used by the occupant of the vehicle M via the communication device 20.

The traveling controller 150 performs driving control for controlling at least one of steering and speed of the vehicle M on the basis of the recognition results from the recognizer 110, the determination results from the determiner 120, or the like. For example, when the determiner 120 determines that the driver is performing sideways-glance driving and this state is maintained for a predetermined time or longer, the traveling controller 150 performs control for stopping the vehicle M at a safe position such as a road shoulder. The traveling controller 150 may perform the driving control such that collision of the vehicle M with an obstacle recognized by the recognizer 110 is avoided. The traveling controller 150 may perform driving control such as an adaptive cruise control system (ACC), a lane keeping assistance system (LKAS), or lane change assist (LCA) by controlling at least one of steering and speed of the vehicle M in accordance with an occupant's instruction input from the HMI 30. ALC is driving control for performing lane change of the vehicle M by allowing a system side to operate at least steering of the vehicle M.

The travel driving force output device 200 outputs a travel driving force (a torque) for allowing the vehicle to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the traveling controller 150 or information input from the accelerator pedal of the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the traveling controller 150 or the information input from the brake pedal of the driving operator 80 such that a brake torque based on a braking operation is output to vehicle wheels. The brake device 210 may include a mechanism for transmitting a hydraulic pressure generated by an operation of the brake pedal to the cylinder via a master cylinder as a backup. The brake device 210 is not limited to the above-mentioned configuration, and may be an electronically controlled hydraulic brake device that controls an actuator on the basis of information input from the traveling controller 150 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the traveling controller 150 or the information input from the steering wheel of the driving operator 80 and changes the direction of the turning wheels.

### Determiner

Details of the functions of the determiner 120 will be specifically described below. In the following description, it is assumed that the determiner 120 compares at least one of a gaze and a face direction of a driver of the vehicle M recognized by the recognizer 110 with a sideways-glance determination area (an example of a sideways-glance determination condition) and determines whether the driver is performing sideways-glance driving.

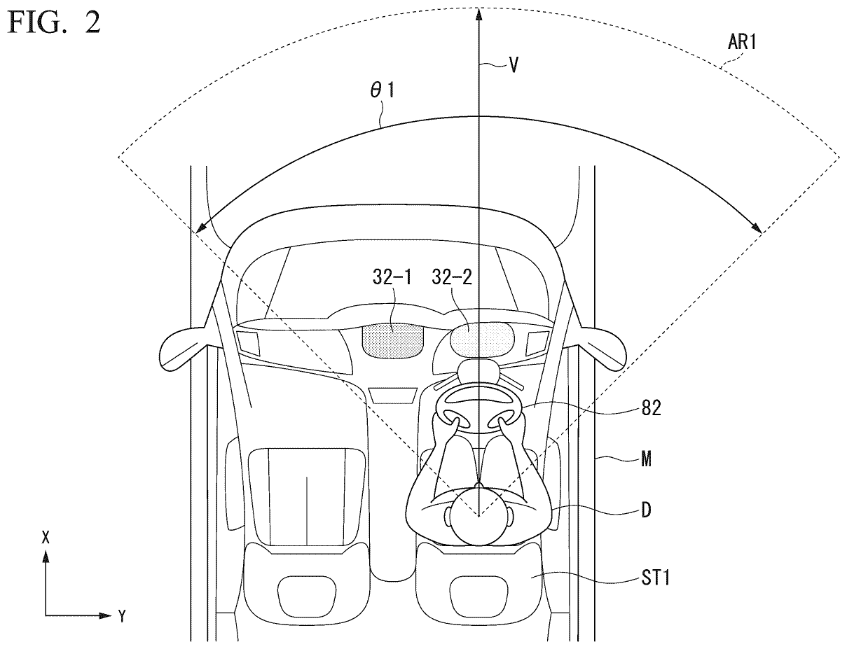

FIG. 2 is a diagram illustrating a relationship between a gaze (a face direction) of a driver and a sideways-glance determination condition. In the example illustrated in FIG. 2, a situation in which a driver D sits on a driver's seat ST1 of the vehicle M and operates a driving operator 80 such as a steering wheel 82 to perform manual driving of the vehicle M is schematically illustrated. In the example illustrated in FIG. 2, displays 32-1 and 32-2 are illustrated. For example, when the vehicle M is traveling straightly ahead (the X-axis direction in the drawing), the determiner 120 sets a sideways-glance determination area AR1 with a predetermined angle to right and left with respect to a traveling direction V of the vehicle M from a position of the head of the driver D as illustrated in FIG. 2. The sideways-glance determination area AR1 is an example of a “first sideways-glance determination condition.” The sideways-glance determination area AR1 may be adjusted according to the speed of the vehicle M, a road shape, or the like. In this case, for example, the sideways-glance determination area AR1 may be set such that an angle (an arc angle) θ1 indicating the magnitude of an arc of the sideways-glance determination area AR1 decreases according to the magnitude of the speed or the angle θ1 increases as a width of a road increases.

In this situation, for example, the determiner 120 determines that the driver D is not performing sideways-glance driving when the gaze of the driver D recognized by the recognizer 110 is included in the angle θ1 of the sideways-glance determination area AR1 and determines that the driver D is performing sideways-glance driving when the gaze is not included in the angle θ1 (or when the state in which the gaze is not included in the angle is maintained for a predetermined time or longer). The determiner 120 may determine the sideways-glance determination by comparing the direction of the head of the driver D recognized by the recognizer 110 with the sideways-glance determination area AR1 instead of (or in addition to) the gaze of the driver D. For example, the determiner 120 performs the sideways-glance determination using the face direction when the gaze of the driver D has not been recognized by the recognizer 110 and the face direction has been recognized.

When the determiner 120 determines that the driver is performing sideways-glance driving, the HMI controller 140 generates sideways-glance alarm information and causes the HMI 30 to output the sideways-glance alarm information. The sideways-glance alarm information may be an alarm image to be displayed on at least one of the displays 32-1 and 32-2 or may be an alarm sound to be output from the speaker 34.

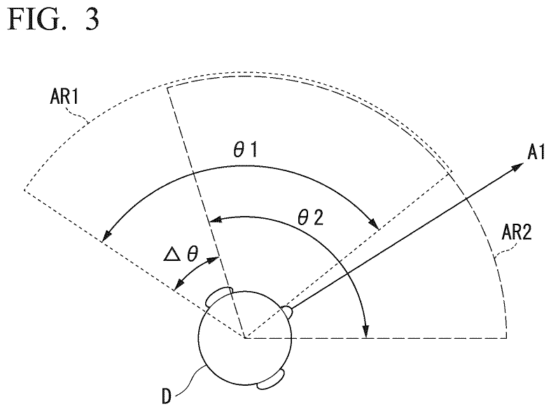

When the turn signal lever 84 is operated by the driver D, the determiner 120 may change the sideways-glance determination area AR1. FIG. 3 is a diagram illustrating a changed sideways-glance determination area. In the example illustrated in FIG. 3, a state in which the sideways-glance determination area is switched (changed) when the turn signal lever 84 is operated to light the right turn signal of the vehicle M is illustrated, and when the turn signal lever 84 is operated to light the left turn signal, right and left can be exchanged.

For example, when the turn signal lever 84 is operated to light the right turn signal, the determiner 120 sets a sideways-glance determination area AR2 obtained by rotating the sideways-glance determination area AR1 to right around the head of the driver D as a new sideways-glance determination area AR1. The sideways-glance determination area AR2 is an example of a “second sideways-glance determination condition.”

In the example illustrated in FIG. 3, since the vehicle M turns to right, the determiner 120 changes the sideways-glance determination area AR1 correlated with straight traveling of the vehicle M to the sideways-glance determination area AR2 at a position obtained by rotationally moving the sideways-glance determination area AR1 by an angle Δθ to right with respect to the head position of the driver D and performs the sideways-glance determination. The angle Δθ may be changed according to the swing level or may be additionally adjusted according to the speed of the vehicle M. In the example illustrated in FIG. 3, the sideways-glance determination area AR1 and the sideways-glance determination area AR2 have the same size (that is, the angle (arc angle) θ1 indicating the size of the sideways-glance determination area AR1 and the angle (arc angle) θ2 indicating the size of the sideways-glance determination area AR2 are the same), but may have different sizes (for example, the angle θ1 and the angle θ2 are different). The angle Δθ, the angle θ1, and the angle θ2 may be adjusted according to a road shape (for example, a width, a curvature, or a connection angle of roads at a crossing) in which the vehicle M is traveling or the like.

For example, it is assumed that a gaze A1 of the driver D is in the situation illustrated in FIG. 3. At this time, when the turn signal lever 84 is not operated, the determiner 120 determines that the driver D is performing sideways-glance driving because the gaze A1 of the driver D is not included in the sideways-glance determination area AR1, but determines that the driver D does not perform sideways-glance driving because the gaze A1 of the driver D is included in the sideways-glance determination area AR2 when the turn signal lever 84 is operated. Accordingly, even when the driver D moves the gaze A1 to right in order to check a situation of a lane change destination, it is possible to make it difficult to determine that the driver D is performing sideways-glance driving (to make it difficult to determine whether the monitoring direction of the driver D is not appropriate).

When the turn signal lever 84 is operated, the determiner 120 may set an area including the sideways-glance determination area AR1 and the sideways-glance determination area AR2 as a determination area or may not perform sideways-glance determination (or does not output sideways-glance alarm information even when it is determined that the driver is performing sideways-glance driving). Accordingly, it is possible to make it difficult to determine that the monitoring direction of the driver D is not appropriate.

When the turn signal device 70 is operated by operation the turn signal lever 84 and then the operation of the turn signal device 70 ends (when lighting of the turn signal ends), the determiner 120 performs the determination on the basis of an original condition (the sideways-glance determination area AR1) as the sideways-glance determination condition.

Lighting control using an operation for the one-touch turn signal function of the turn signal lever 84 is performed by the turn signal device 70 and the lighting controller 130 according to the present embodiment. Accordingly, the determiner 120 performs determination control for the operation for the one-touch turn signal function.

### Turn Signal Lever

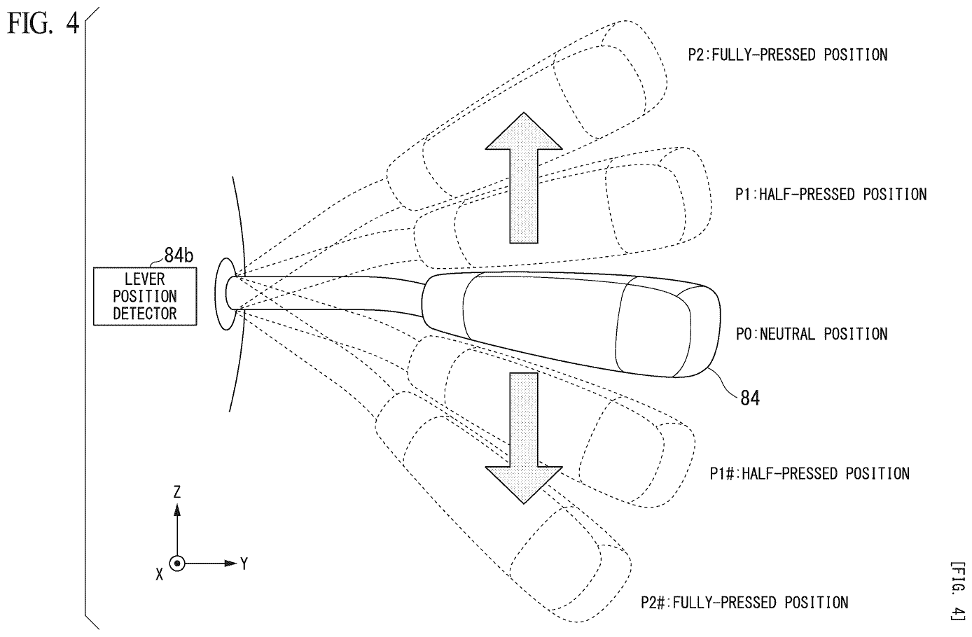

The operation position of the turn signal lever will be described below. FIG. 4 is a diagram illustrating the operation position of the turn signal lever 84. In the drawing, the X axis represents an advancing and retreating direction (longitudinal) of the vehicle M, the Y axis represents a lane width direction (lateral) of the vehicle M, and the Z axis represents an up-down direction (vertical) of the vehicle M. For example, one end of the turn signal lever 84 is supported at a predetermined place (for example, a steering column). When the turn signal lever 84 is operated by the driver, the turn signal lever 84 rotates in the vertical direction (the Z direction) around the support place of the one end.

A neutral position P0 is a position at which the turn signal device 70 does not operate, and that position is held when the turn signal lever 84 is not operated. When the turn signal lever 84 rotates upward around the neutral position P0 and moves to a half-pressed position (a left first operating position) P1 or a fully-pressed position (a left second operating position) P2 through the operation of the driver D, the turn signal device 70 operates. “Operating” means an operation of lighting (flickering) a lamp (a turn lamp) serving as a turn signal.

The half-pressed position P1 is a position at which the left turn signal device 70 of the vehicle M operates, that position is held while the turn signal lever 84 is being operated, and the position of the turn signal lever 84 moves to the neutral position P0 at the timing at which the turn signal lever 84 is not operated any more. When the driver D pushes up the turn signal lever 84 to the half-pressed position P1, the turn signal device 70 operates, and the left turn signal is lighted (flickered) a predetermined number of times (for example, 3) or for a predetermined time (for example, several seconds) and ends its operation. When the driver D removes the hand while operating, the turn signal lever 84 moves automatically to the neutral position P0, and lighting of the turn signal is continued until the light ends. The half-pressed position P1 is positioned, for example, when the vehicle M performs lane changes from the traveling lane to a left neighboring lane.

The fully-pressed position P2 is a position at which the left turn signal of the vehicle M is lighted, and that position is held when the turn signal lever 84 is not operated. That is, when the driver D pushes up the turn signal lever 84 to the fully-pressed position P2 at a time, the turn signal device 70 continues to operate to light the left turn signal until the driver D pushes down the turn signal lever 84. The fully-pressed position P2 is positioned, for example, when the vehicle M turns to left.

Similarly to the example illustrated in the drawing, when the turn signal lever 84 rotates downward around the neutral position P0 and moves to a half-pressed position P1 #or a fully-pressed position P2 #, the turn signal device 70 operates to light the right turn signal of the vehicle M. The half-pressed position (a right first operating position) P1 #is a position at which the right turn signal device 70 of the vehicle M operates, that position is held while the turn signal lever 84 is being operated, and the position of the turn signal lever 84 moves to the neutral position P0 at the timing at which the turn signal lever 84 is not operated any more. For example, when the driver D pushes down the turn signal lever 84 to the half-pressed position P1 #, the turn signal device 70 operates, and the right turn signal is lighted (flickered) a predetermined number of times (for example, 3) or for a predetermined time (for example, several seconds) and ends its operation. When the driver D removes the hand in this state, the turn signal lever 84 moves automatically to the neutral position P0, and the operating right turn signal device 70 stops. The half-pressed position P1 #is positioned, for example, when the vehicle M performs lane changes from the traveling lane to a right neighboring lane.

The fully-pressed position (a right second operating position) P2 #is a position at which the right turn signal of the vehicle M is lighted, and that position is held when the turn signal lever 84 is not operated. That is, when the driver D pushes down the turn signal lever 84 to the fully-pressed position P2 #at a time, the right turn signal device 70 continues to operate until the driver pushes up the turn signal lever 84. The fully-pressed position P2 #is positioned, for example, when the vehicle M turns to right.

For example, the lever position detector 84a detects whether the turn signal lever 84 is positioned at the positions such as the neutral position P0, the half-pressed position P1, the fully-pressed position P2, the half-pressed position P1 #, and the fully-pressed position P2 #. The turn signal lever 84 may return to the neutral position P0 automatically when the steering wheel returns to the neutral position using rotation of a shaft (a rotation shaft) of the steering wheel after the turn signal lever 84 has moved to the fully-pressed position P2 or P2 #. When lane change of the vehicle M is performed, the turn signal lever 84 is positioned at the half-pressed position P1 or the half-pressed position P1 #corresponding to the direction of the lane change destination by the driver D. That is, a function (control) when the turn signal lever 84 is positioned at the half-pressed position P1 or the half-pressed position P1 #corresponds to the one-touch turn signal function (control).

For example, when the turn signal lever 84 is positioned at the half-pressed position P1 or P1 #, the determiner 120 makes it more difficult to determine that the monitoring direction of the driver D is not appropriate (that is, makes it more difficult to determine that the driver D is performing sideways-glance driving) in comparison with before the turn signal lever 84 is operated until the turn signal lever 84 returns automatically to the neutral position P0 and the predetermined condition is satisfied.

### Operation of Turn Signal Lever and Determination Control

A relationship between the operation of the turn signal lever 84 (hereinafter referred to as a “turn signal operation”) and the determination process performed by the determiner 120 according to the present embodiment will be described below. In the following description, a process when the turn signal lever 84 is positioned at the half-pressed position P1 or P1 #by the driver D will be mainly described. In the following description, a first example in which lateral behavior (movement in a lane width direction) of the vehicle M occurs after the turn signal operation has been performed and a second example in which the lateral behavior does not occur will be divisionally described.

### First Example

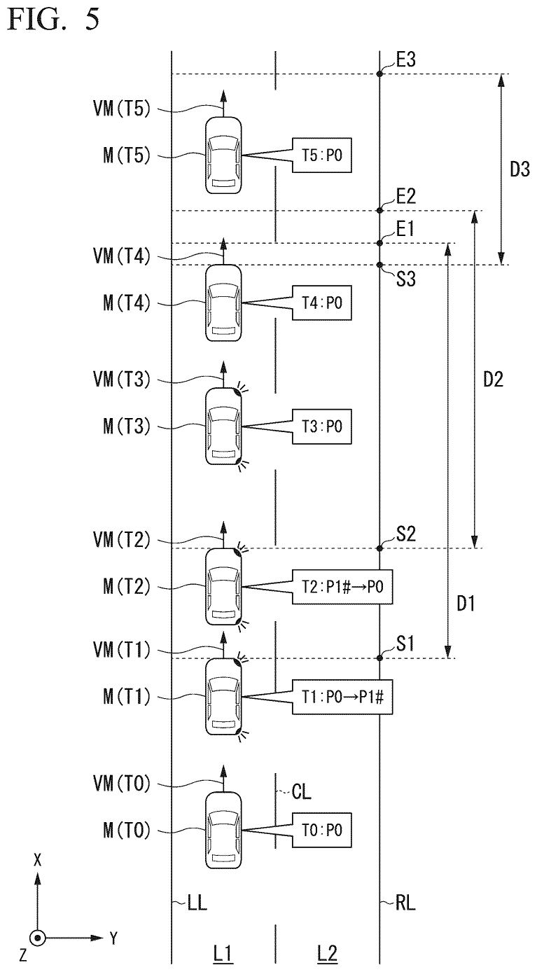

FIG. 5 is a diagram illustrating the turn signal operation and the determination process in the first example. In the following description, it is assumed that the position and the speed of the vehicle M at time T* are defined as M(T) and VM(T*). In the following description, it is assumed that T0 is the earliest and the time becomes later in the order of times T1, T2, T3, T4, and T5.

In the example illustrated in FIG. 5, two lanes L1 and L2 extending in the same direction (the X-axis direction in the drawing) are illustrated. The lane L1 is defined by lane marking lines LL and CL, and the lane L2 is defined by lane marking lines CL and RL. From the viewpoint of the lane L1, the lane L2 is a neighboring lane which is lane changeable. In the example illustrated in FIG. 5, the vehicle M is traveling in the lane L1 at a speed VM. In the example illustrated in FIG. 5, a position or a change in position of the turn signal lever 84 detected by the lever position detector 84a at each timing of times T0 to T5 is illustrated.

For example, when the turn signal lever 84 is positioned at the half-pressed position P1 or P1 #, the determiner 120 makes it more difficult to determine that the driver D is performing sideways-glance driving in comparison with before the turn signal lever 84 is operated until the turn signal lever 84 returns to the neutral position P0 and a predetermined condition is satisfied. Making it difficult to determine may be, for example, looking to not determine that the driver is performing sideways-glance driving or loosening the sideways-glance determination condition (decreasing an area in which sideways-glance driving is determined/increasing an area in which sideways-glance driving is not determined).

In the first example, for example, a situation in which the driver D positions the turn signal lever 84 at the half-pressed position P1 #and lights the turn signal in order to perform lane change of the vehicle M traveling in the lane L1 to the lane L2, does not perform the lane change to the lane L2 due to reasons another vehicle, an obstacle, or the like is present in the lane L2 which is a neighboring lane, and travels in the lane L1 without lateral behavior is illustrated.

In this situation, at time T0, the turn signal lever 84 is positioned at the neutral position P0. At time T1, the turn signal lever 84 moves from the neutral position P0 to the half-pressed position P1 #at which the right turn signal operates through an operation of the driver D. At time T2, the driver D removes the hand from the turn signal lever 84, and thus the turn signal lever 84 moves (returns) from the half-pressed position P1 #to the neutral position P0. In the example illustrated in FIG. 5, it is assumed that the turn signal lever 84 is positioned at the neutral position P0 after time T2.

The lighting controller 130 continues to light (flicker) the turn signal until a predetermined time has elapsed or the turn signal is flickered a predetermined number of flickering times after being instructed at a time point at which the turn signal lever 84 has been positioned at the half-pressed position P1 #. Accordingly, at time T3 before the predetermined time has elapsed or before the predetermined number of flickering times is reached, lighting of the turn signal is maintained.

After the turn signal lever 84 has moved to the half-pressed position P1 #, the driver D moves the gaze or rotates the face direction to check the right side (which includes the front right side and the rear right side) of the vehicle M on which the lane L2 is located for the purpose of check of safety in the lane L2 to which lane change is performed. However, when sideways-glance determination is carried out at this timing, the gaze or the face direction for the lane change is determined to be sideways-glance driving (the monitoring direction of the driver is not appropriate).

Therefore, the determiner 120 makes it more difficult to determine that the driver D is performing sideways-glance driving in comparison with before the turn signal lever 84 is operated until a first predetermined time has elapsed or the vehicle M travels (moves) by a first predetermined distance or more after time T1 at which the turn signal lever 84 has been operated. For example, in the example illustrated in FIG. 5, when a time point at which the first predetermined time has elapsed after time T1 is time T4, the determiner 120 makes it difficult to determine that the driver D is performing sideways-glance driving until time T4. The determiner 120 may make it difficult to determine that the driver D is performing sideways-glance driving until the vehicle M reaches a point E1 which is separated by the first predetermined distance D1 from a point S1 at which the vehicle M(T1) is present when the turn signal lever 84 has been operated.

In the aforementioned example, time T1 at which the turn signal lever 84 has been operated is used as a reference, but it may be made more difficult to determine that the driver D is performing sideways-glance driving in comparison with before the turn signal lever 84 is operated until a second predetermined time has elapsed or the vehicle M travels (moves) by a second predetermined distance or more after time T2 at which the turn signal lever 84 has returned to the neutral position P0, instead. In this case, when the time point at which the second predetermined time has elapsed after time T2 is time T5, the determiner 120 makes it difficult to determine that the driver D is performing sideways-glance driving until time T5. The determiner 120 may make it difficult to determine that the driver D is performing sideways-glance driving until the vehicle M reaches a point E2 which is separated by the second predetermined distance D2 from a point S2 at which the vehicle M(T2) is present when the turn signal lever 84 has returned to the neutral position P0.

In the aforementioned example, instead of times T1 and T2, it may be made more difficult to determine that the driver D is performing sideways-glance driving in comparison with before the turn signal lever 84 is operated until a third predetermined time has elapsed or the vehicle M travels (moves) by a third predetermined distance or more after time T4 at which lighting of the turn signal has ended. In this case, when the time point at which the third predetermined time has elapsed after time T4 is time T5, the determiner 120 makes it difficult to determine that the driver D is performing sideways-glance driving until time T5. The determiner 120 may make it difficult to determine that the driver D is performing sideways-glance driving until the vehicle M reaches a point E3 which is separated by the third predetermined distance D3 from a point S3 at which the vehicle M(T4) is present when lighting of the turn signal has ended.

The first to third predetermined times described above may be the same time, or at least one thereof may be a different time. The first to third predetermined distances D1 to D3 described above may be the same time, or at least one thereof may be a different distance. When different times or distances are employed, for example, the time decreases in the order of the first predetermined time, the second predetermined time, and the third predetermined time, and the distance decreases in the order of the first predetermined distance D1, the second predetermined distance D2, and the third predetermined distance D3. Since there is a higher likelihood that the driver D will not see the lane change destination side as a longer time has elapsed or a traveling distance becomes longer after the turn signal operation has been performed, it is possible to more appropriately detect a state (a sideways-glance state) of the driver D by decreasing the predetermined time and the predetermined distance with respect to a time point at which the turn signal has been operated.

According to the first example, when the turn signal lever 84 returns to the neutral position P0 by removing a hand after the turn signal lever has been operated such as a one-touch turn signal, it is possible to curb sideways-glance determination in a predetermined period or distance even if the turn signal lever has returned to the neutral position P0. Accordingly, it is possible to prevent surrounding monitoring from being determined to be a sideways glance when lane change or the like is performed using the one-touch turn signal and to prevent an occupant from feeling troublesome from an unnecessary sideways-glance alarm or the like.

### Second Example

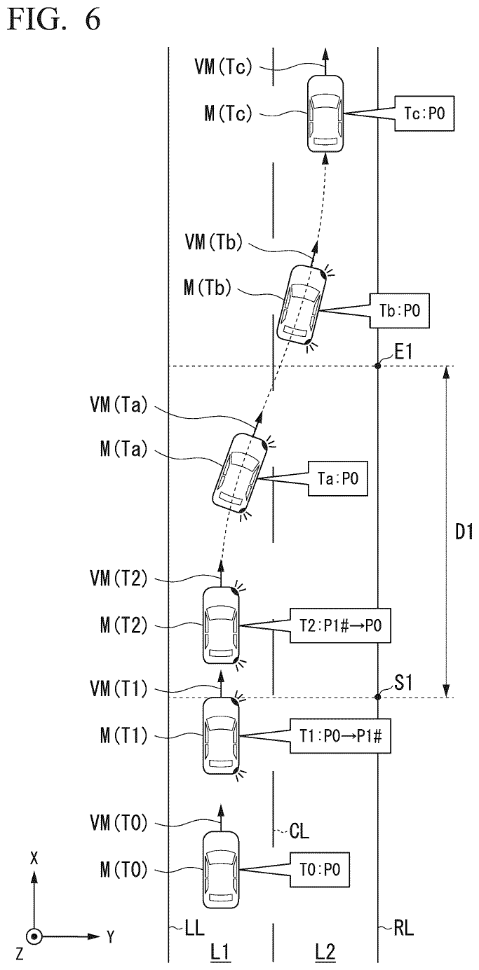

FIG. 6 is a diagram illustrating the turn signal operation and the determination process in the second example. The example illustrated in FIG. 6 is different from the example illustrated in FIG. 5 in that the vehicle M performs lane change from the lane L1 to the lane L2 after the turn signal lever 84 has been operated. Out of times Ta, Tb, and Tc illustrated in FIG. 6, it is assumed that Ta is the earliest and the time becomes later in the order of times Tb and Tc. Time Ta is later than time T2, and the turn signal lever 84 after time T2 is positioned at the neutral position P0. The behavior of the vehicle M, the operation of the turn signal lever 84, and the liker at times T0 to T2 in the second example are the same as times T0 to T2 in the first example, and thus description thereof will be omitted.

At time Ta, for example, when lateral behavior of the vehicle M or an operation causing the lateral behavior has occurred before a predetermined time has elapsed or in a state in which the vehicle D has moved by less than a predetermined distance, the determiner 120 makes it difficult to determine that the driver D is performing sideways-glance driving until the lateral behavior or the operation causing the lateral behavior ends even if the predetermined time has elapsed or the vehicle M has traveled by the predetermined distance or longer.

For example, in the example illustrated in FIG. 6, it is assumed that the sideways-glance determination is curbed until the vehicle M travels by a predetermined distance D1 from the timing of time T1 at which the turn signal lever 84 has been operated by the driver. Since lateral behavior of the vehicle M has been detected at time Ta until the vehicle M travels by the distance D1 in this state, the determiner 120 makes it difficult to determine that the driver D is performing sideways-glance driving even after the vehicle M has reached the point E1.

Determining whether the vehicle M carries out lateral behavior or determining whether an operation causing the lateral behavior is performed will be described below. For example, the determiner 120 determines whether the vehicle M carries out lateral behavior or whether an operation causing the lateral behavior is performed on the basis of the information acquired from the vehicle sensor 40, the information acquired from the driving operator, or the results of recognition from the recognizer 110.

For example, the determiner 120 determines that the vehicle M carries out lateral behavior when a moving distance of a lateral position (a moving distance in the lane width direction) of the vehicle M or an amount of movement per unit time is equal to or greater than a first threshold value and determines that the vehicle M does not carry out lateral behavior when the moving distance or the amount of movement is less than the first threshold value. The determiner 120 determines that the vehicle M carries out lateral behavior when a direction of the vehicle M with respect to the extending direction of the traveling lane or an amount of change in the direction is equal to or greater than a second threshold value and determines that the vehicle M does not carry out lateral behavior when the direction or the amount of change in the direction is less than the second threshold value. The determiner 120 may determine that the vehicle M carries out lateral behavior when a lateral acceleration (a lateral G) is equal to or greater than a third threshold value and determines that the vehicle M does not carry out lateral behavior when the lateral acceleration is less than the third threshold value.

The determiner 120 determines that the operation causing lateral behavior of the vehicle M is performed when a steering torque is equal to or greater than a fourth threshold value and determines that the operation is not performed when the steering torque is less than the fourth threshold value. The determiner 120 may determine that the operation causing lateral behavior of the vehicle M is performed when a rudder angle differential is equal to or greater than a fifth threshold value and determine that the operation is not performed when the rudder angle differential is less than the fifth threshold value. The determiner 120 may determine that the operation causing lateral behavior of the vehicle M is performed when a rudder angle is equal to or greater than a sixth threshold value and determine that the operation is not performed when the rudder angle is less than the sixth threshold value.

The determiner 120 may perform the determination process using at least one of various determination conditions associated with lateral behavior and may add an additional condition in which the speed VM of the vehicle M is equal to or greater than a seventh threshold value to the conditions used to determine that the vehicle M carries out lateral behavior or to determine that an operation causing the lateral behavior is performed.

In the example illustrated in FIG. 6, it is assumed that it is made difficult to determine that the driver D is performing sideways-glance driving until the vehicle M reaches the point E1 which is separated by the first predetermined distance D1 from the point S1 at which the vehicle M(T1) is present at time T1 at which the turn signal lever 84 has been operated and lateral behavior of the vehicle M or an operation causing lateral behavior occurs in the middle to the point E1. In this case, the determiner 120 makes it difficult to determine that the driver D is performing sideways-glance driving until the lateral behavior or the operation causing lateral behavior ends even if the vehicle M has reached the point E1. Accordingly, it is possible to more appropriately detect a driver state according to the situation of the vehicle M.

Instead of until the lateral behavior or the operation causing lateral behavior ends, the determiner 120 may make it difficult to determine that the driver D is performing sideways-glance driving until the vehicle M crosses a marking line defining the lane L1 in which the vehicle M is traveling or presence of a right or left marking line (a lane marking line) of the vehicle M is recognized after the vehicle M has carried out lateral behavior. “Crossing a marking line defining the lane L1 in which the vehicle M is traveling” may be, for example, that a predetermined point (for example, the center of gravity, the center, or a front end) on the vehicle M is present on the lane marking line CL partitioning the traveling lane L1 and the neighboring lane L2 or that the whole vehicle M crosses the lane marking line and is present on the lane L2. “Recognizing presence of the right and left lane marking lines of the vehicle M” may be, for example, that the vehicle M is recognized to travel at the center (which includes a predetermined allowable range) of the lane which is a lane change destination or that the direction of the vehicle M is parallel to the extending direction (which includes a predetermined allowable range) of the lane.

In the example illustrated in FIG. 6, when it is determined that lateral behavior is carried out until the vehicle M reaches the point E1, the determiner 120 makes it difficult to determine that the driver D is performing sideways-glance driving until time Tb at which the whole vehicle M is present in the lane L2. In the example illustrated in FIG. 6, when it is determined that lateral behavior is carried out until the vehicle M reaches the point E1, the determiner 120 may make it difficult to determine that the driver D is performing sideways-glance driving until time Tc at which the vehicle M travels at the center of the lane L2.

According to the second example, it is possible to continue to curb the sideways-glance determination until lateral behavior such as lane change based on an operation of the turn signal lever 84 or a lateral behavior operation is completed. According to the second example, it is possible to release curbing of the sideways-glance determination when the lane change converges. As a result, it is possible to more appropriately detect a driver state.

In the embodiment, driving control using the traveling controller 150 may be performed on the vehicle M. In this case, the traveling controller 150 starts ALC with an operation of the turn signal lever 84 as a trigger. Accordingly, the operation of the turn signal lever 84 includes an operation for starting ALC of the vehicle M. A predetermined condition when it is made more difficult to determine the monitoring direction of the driver D is not appropriate (it is made more difficult to determine that the driver D is performing sideways-glance driving) in comparison with before the turn signal lever 84 is operated until the turn signal lever 84 returns to the neutral position and the predetermined condition is satisfied may include a condition in which ALC is completed. In this way, by loosening sideways-glance determination at the time of execution of ALC, it is possible to prevent sideways-glance driving from being determined to forcibly cancel the driving control such as ALC.

In the embodiment, the predetermined condition may include a condition in which the vehicle M moves on an exclusive road (for example, an expressway or a toll road) or a condition in which the vehicle M is moving at a speed VM equal to or higher than a predetermined speed (a speed relative to a speed limit of the exclusive road in this case). Accordingly, when the vehicle M is traveling at a high seed, lane change is likely to be performed using a one-touch turn signal, and thus it is possible to perform appropriate driving control by curbing the sideways-glance determination in this case.

In the embodiment, the predetermined condition may include a first predetermined condition which is used when the vehicle M is traveling on an exclusive road or when the vehicle M is traveling at a speed VM equal to or higher than a predetermined speed and a second predetermined condition which is used when the vehicle M is traveling on a road (for example, a regular road) other than an exclusive road or when the vehicle M is traveling at a speed lower than the predetermined speed. In this case, the first predetermined condition is made more difficult to satisfy than the second predetermined condition. Making it difficult to satisfy a condition includes increasing the number of conditions to be satisfied or adjusting a value or a range to make it difficult to satisfy the condition. For example, an example of making it difficult to satisfy a condition includes setting a predetermined time or a predetermined distance widening a sideways-glance determination area to be greater than the second predetermined condition such that it is made difficult to determine that the driver D is performing sideways-glance driving. Accordingly, it is possible to perform more appropriate sideways-glance driving according to a situation of a traveling road.

In the embodiment, when lane change is completed, the determiner 120 returns the sideways-glance determination condition to an original and performs the sideways-glance determination when a state in which a predetermined condition is not satisfied is changed to a state in which the predetermined condition is satisfied and causes the HMI controller 140 to output sideways-glance alarm information when it is determined that the driver is performing sideways-glance driving. The HMI controller 140 may cause the HMI 30 to output information indicating that it is made difficult to determine that the monitoring direction of the driver D is not appropriate (it is made difficult to determine that the driver D is performing sideways-glance driving) in a traveling state for lane change and notify the driver. Accordingly, the driver can move the gaze or the face direction to see a situation of a lane change destination without hesitation.

### Process Flow

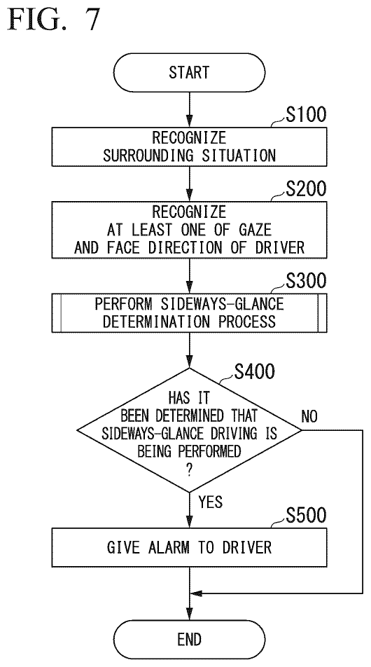

A process flow that is performed by the driving support device 100 according to the embodiment will be described below. In the following description, a process associated with sideways-glance determination of a driver D in the process flow performed by the driving support device 100 will be mainly described. FIG. 7 is a flowchart illustrating an example of the process flow performed by the driving support device 100 according to the embodiment. The process flow illustrated in FIG. 7 may be repeatedly performed at predetermined timings or with a predetermined period.

In the example illustrated in FIG. 7, the recognizer 110 recognizes the surrounding situation of the vehicle M on the basis of the output from the detection device DD (Step S100). Then, the recognizer 110 recognizes at least one of a gaze and a face P direction of a driver of the vehicle M (Step S200). Then, the determiner 120 performs a sideways-glance determination process using at least one of the recognized gaze and the recognized face direction of the driver D (Step S300). Details of the sideways-glance determination process will be described later.

Then, the HMI controller 140 determines whether the driver D is performing sideways-glance driving on the basis of the result of sideways-glance determination from the determiner 120 (Step S400). When it is determined that the driver D is performing sideways-glance driving, the HMI controller 140 outputs an alarm against sideways-glance driving to the driver D (Step S500). Accordingly, the process flow of the flowchart ends. When it is determined in the process of Step S400 that the driver D is not performing sideways-glance driving, the process flow ends without performing any process.

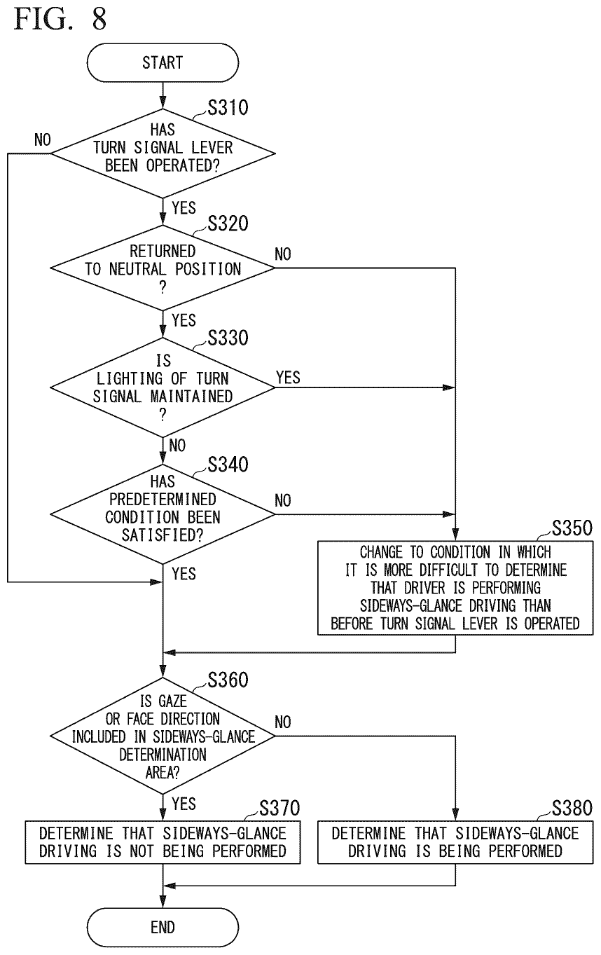

FIG. 8 is a flowchart illustrating an example of the sideways-glance determination process. The example illustrated in FIG. 8 corresponds to the process of Step S300. In the example illustrated in FIG. 8, the determiner 120 determines whether the turn signal lever 84 has been operated by the driver D (Step S310). When it is determined that the turn signal lever 84 has been operated, the determiner 120 determines whether the turn signal lever 84 has returned to the neutral position (Step S320). When it is determined that the turn signal lever 84 has returned to the neutral position, the determiner 120 determines whether the turn signal continues to be lighted (flickered) even if the turn signal lever 84 has returned to the neutral position using a one-touch turn signal function (Step S330). When it is determined that the turn signal does not continue to be lighted, the determiner 120 determines whether a predetermined condition has been satisfied (Step S340).

Here, when it is determined in the process of Step S340 that the predetermined condition has not been satisfied, when it is determined in the process of Step S320 that the turn signal lever 84 has not returned to the neutral position, or when it is determined in the process of Step S330 that the turn signal continues to be lighted, the determiner 120 changes the sideways-glance determination condition to a condition in which it is made more difficult to determine that the driver D is performing sideways-glance driving in comparison with before the turn signal lever 84 has been operated (Step S350). Changing to a condition in which it is made more difficult to determine that the driver D is performing sideways-glance driving includes, for example, widening the sideways-glance determination area (a range in which sideways-glance driving is not determined), not determining that the driver D is performing sideways-glance driving, or performing control such that it is determined that the driver D is performing sideways-glance driving but a sideways-glance alarm is not issued.

Then, when it is determined in the process of Step S310 that the turn signal lever 84 has not been operated, when it is determined in the process of Step S340 that the predetermined condition has been satisfied, or when the process of Step S350 has been performed, the determiner 120 determines whether the gaze or the face direction of the driver is included in a predetermined sideways-glance determination area (Step S360). When it is determined that the gaze or the face direction is included in the sideways-glance determination area, the determiner 120 determines that the driver D is not performing sideways-glance driving (Step S370). When it is determined that the gaze or the face direction is not included in the sideways-glance determination area, the determiner 120 determines that the driver D is performing sideways-glance driving (Step S380). Accordingly, the process flow of the flowchart ends.

Instead of changing to the condition in which it is made more difficult to determine that the driver is performing sideways-glance driving in the process of Step S350 in FIG. 8, a process of performing adjustment such that it is not determined that the driver is performing sideways-glance driving even when it is determined that the gaze or the face direction is not included in the sideways-glance determination area may be performed in the process of Step S360 subsequent thereto.

### Modified Example

In the embodiment, when the determiner 120 determines that the driver is performing sideways-glance driving, the traveling controller 150 may perform driving control for moving the vehicle M to a safe position and stopping the vehicle at the safe position instead of (or in addition to) the control for outputting a sideways-glance alarm. Accordingly, for example, when the driver is performing sideways-glance driving due to bad conditions, it is possible to stop the vehicle M at a safe position and to more appropriately secure safety of the driver.

The operator for lighting the direction indicator in the embodiment is not the turn signal lever 84, but may be a mechanical switch provided on the steering wheel 82 or may be a graphical user interface (GUI) switch provided on the display 32 or the like of the HMI 30.

According to the aforementioned embodiment, the driver state detection device includes the recognizer 110 configured to recognize at least one of a gaze and a face direction of a driver of a vehicle M (an example of a mobile object), the determiner 120 configured to determine whether a monitoring direction of the driver is appropriate on the basis of the result of recognition from the recognizer 110, and the lighting controller 130 configured to perform lighting control of a direction indicator according to the driver's operation of an operator for lighting a direction indicator of the vehicle M and to perform control such that lighting is maintained even when the operator returns to a neutral position. The determiner 120 makes it more difficult to determine that the monitoring direction of the driver is not appropriate in comparison with before the operator has been operated until the operator returns to the neutral position and a predetermined condition is satisfied. Accordingly, it is possible to more appropriately detect a driver state.

For example, according to the embodiment, the sideways-glance determination can be curbed continuously in a predetermined period even when the turn signal lever 84 (operator) has returned to the neutral position after a one-touch turn signal has been operated. Specifically, even when the turn signal lever 84 has returned automatically to the neutral position, the sideways-glance determination can continue to be curbed by waiting for a predetermined traveling distance or a predetermined time of the vehicle. Return of the determination condition is controlled on the basis of determination of the predetermined time or distance or convergence information of vehicle behavior including a rudder angle. Accordingly, it is possible to appropriately switch the determination condition according to the situation of the vehicle M and to more appropriately detect a driver state (such as sideways-glance driving) using the determination condition.

The above-mentioned embodiment can be expressed as follows:
A driver state detection device including:
   a storage medium storing computer-readable instructions; and
   a processor connected to the storage medium,
   wherein the processor executes the computer-readable instructions to perform:
      recognizing at least one of a gaze and a face direction of a driver of a mobile object;
      determining whether a monitoring direction of the driver is appropriate on the basis of a result of recognition;
      performing lighting control of a direction indicator of the mobile object according to the driver's operation of an operator for lighting the direction indicator and performing control such that lighting is maintained even when the operator returns to a neutral position; and
      making it more difficult to determine that the monitoring direction of the driver is not appropriate in comparison with before the operator is operated until the operator returns to the neutral position and a predetermined condition is satisfied.

While exemplary embodiments of the present invention have been described above, the present invention is not limited to the embodiments and can have various modifications and substitutions applied thereto without departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A driver state detection device comprising:
a recognizer configured to recognize at least one of a gaze and a face direction of a driver of a mobile object;
a determiner configured to determine whether a monitoring direction of the driver is appropriate on the basis of a result of recognition from the recognizer; and
a lighting controller configured to perform lighting control of a direction indicator of the mobile object according to the driver's operation of an operator for lighting the direction indicator and to perform control such that lighting is maintained even when the operator returns to a neutral position,
wherein the determiner makes it more difficult to determine that the monitoring direction of the driver is not appropriate in comparison with before the operator is operated until the operator returns to the neutral position and a predetermined condition is satisfied.

2. The driver state detection device according to claim 1, wherein the predetermined condition includes a condition in which a predetermined time has elapsed or the mobile object has moved by a predetermined distance or more after the operator has been operated or the operator has returned to the neutral position.

3. The driver state detection device according to claim 1, wherein the predetermined condition includes a condition in which a predetermined time has elapsed or the mobile object has moved by a predetermined distance or more after lighting of the direction indicator has ended.

4. The driver state detection device according to claim 2, wherein, when lateral behavior of the mobile object or an operation for causing lateral behavior occurs before the predetermined time has elapsed or in a state in which the mobile object has moved by less than the predetermined distance, the determiner makes it more difficult to determine that the monitoring direction of the driver is not appropriate until the lateral behavior or the operation for causing the lateral behavior ends even if the predetermined time has elapsed or the mobile object has moved by the predetermined distance or more.

5. The driver state detection device according to claim 2, wherein, when lateral behavior of the mobile object or an operation for causing the lateral behavior occurs before the predetermined time has elapsed or in a state in which the mobile object has moved by less than the predetermined distance, the determiner makes it more difficult to determine that the monitoring direction of the driver is not appropriate until the mobile object crosses a marking line of a lane in which the mobile object is moving or until right and left marking lines of the mobile object are recognized after the mobile object has adopted the lateral behavior even if the predetermined time has elapsed or the mobile object has moved by the predetermined distance or more.

6. The driver state detection device according to claim 1, wherein the operation of the operator is an operation of starting automatic lane change of the mobile object, and
wherein the predetermined condition includes a condition in which the automatic lane change has been completed.

7. The driver state detection device according to claim 1, wherein the predetermined condition includes a condition in which the mobile object is moving on an exclusive road or a condition in which the mobile object is moving at a predetermined speed or higher.

8. The driver state detection device according to claim 1, wherein the predetermined condition includes a first predetermined condition which is used when the mobile object is moving on an exclusive road or the mobile object is moving at a predetermined speed or higher and a second predetermined condition which is used when the mobile object is moving on a road other than the exclusive road or the mobile object is moving at lower than the predetermined speed, and
wherein the first predetermined condition is satisfied more difficultly than the second predetermined condition.

9. A driver state detection method that is performed by a computer, the driver state detection method comprising:
recognizing at least one of a gaze and a face direction of a driver of a mobile object;
determining whether a monitoring direction of the driver is appropriate on the basis of a result of recognition;
performing lighting control of a direction indicator of the mobile object according to the driver's operation of an operator for lighting the direction indicator and performing control such that lighting is maintained even when the operator returns to a neutral position; and
making it more difficult to determine that the monitoring direction of the driver is not appropriate in comparison with before the operator is operated until the operator returns to the neutral position and a predetermined condition is satisfied.

10. A non-transitory computer-readable storage medium storing a program, the program causing a computer to perform:
recognizing at least one of a gaze and a face direction of a driver of a mobile object;
determining whether a monitoring direction of the driver is appropriate on the basis of a result of recognition;
performing lighting control of a direction indicator of the mobile object according to the driver's operation of an operator for lighting the direction indicator and performing control such that lighting is maintained even when the operator returns to a neutral position; and
making it more difficult to determine that the monitoring direction of the driver is not appropriate in comparison with before the operator is operated until the operator returns to the neutral position and a predetermined condition is satisfied.
